(19) United States
(12) Patent Application Publication
(10) Pub. No.: US 2023/0311357 A1
(43) Pub. Date: Oct. 5, 2023

(54) CUTTING SYSTEM, CUTTING DEVICE, AND CUTTER UNIT

(71) Applicant: MCK CO., LTD., Kita-ku, Nagoya-shi, Aichi (JP)

(72) Inventor: Yuta YOSHIDA, Tokyo (JP)

(73) Assignee: MCK CO., LTD., Kita-ku, Nagoya-shi, Aichi (JP)

(21) Appl. No.: 18/008,101

(22) PCT Filed: Jun. 4, 2021
(86) PCT No.: PCT/JP2021/021287

§ 371 Date: Dec. 2, 2022

(30) Foreign Application Priority Data
Jun. 5, 2020 (JP) 2020-098974

(51) Int. Cl. B26D 5/06; B26D 1/18; B26D 7/26; B25J 11/00

(52) U.S. Cl. CPC B26D 5/06; B25J 11/0055; B26D 1/185; B26D 7/2621

(57) ABSTRACT

A cutting system includes an articulated robot and a cutting device, and the cutting device includes a body and a cutter unit. The body includes a motor that rotates a rotary blade. The cutter unit includes a case housing a part of the rotary blade and a guiding part linked to the case and housing another part of the rotary blade, and has, between the case and the guiding part, a space for cutting into which an object to be cut (a film) is introduced. The articulated robot moves the cutting device and the object to be cut relative to each other. A part of the rotary blade is exposed in the space for cutting, and the cutter unit of the cutting device is attachable to and detachable from the body.

### TECHNICAL FIELD

The present invention relates to a cutting system, a cutting device, and a cutter unit.

### BACKGROUND ART

Conventionally, a cutting device that cuts an object such as a film made of a resin attached to a workpiece such as a substrate is known.

As such a cutting device, for example, a device that cuts a laminate film into a length that suits a length of a substrate when the laminate film is attached to the substrate is known.

Note that a technique concerning a cutting device is, for example, described in Patent Literature 1.

### CITATION LIST

### Patent Literature

PTL 1: Japanese Unexamined Patent Application Publication No. 2010-208311

### SUMMARY OF INVENTION

### Technical Problem

However, in recent years, substrates and the like that have complicated shapes such as a curved surface shape are used. In a case where a film attached to such a substrate is cut, it is difficult to cut the film properly according to a conventional method such as a method of successively cutting a film by a cutter roller or a method of cutting a film by linearly moving a cutter.

Furthermore, in a case where one end of a film attached to a substrate having a complicated shape is a free end when a portion of the film that sticks out from an end edge of the substrate is to be cut, a method that requires cutting a film while giving tension cannot be used.

That is, according to conventional methods for cutting a sheet-shaped member such as a film, it is sometimes impossible to properly cut the sheet-shaped member.

An object of the present invention is to realize a technique of more properly cutting a sheet-shaped member.

### Solution to Problem

In order to attain the above object, a cutting system according to an embodiment of the present invention
a cutting device including a body having a motor that rotates a rotary blade and a cutter unit that includes a case housing a part of the rotary blade and a guiding part linked to the case and housing another part of the rotary blade and has, between the case and the guiding part, a space for cutting into which an object to be cut is introduced; and
a transport device that moves the cutting device and the object to be cut relative to each other,
wherein a part of the rotary blade is exposed in the space for cutting, and the cutter unit of the cutting device is attachable to and detachable from the body.

### Advantageous Effects of Invention

According to the present invention, it is possible to provide a technique of more properly cutting a sheet-shaped member.

### BRIEF DESCRIPTION OF DRAWINGS

FIG. 1 is a schematic view illustrating an overall configuration of a cutting system 1 according to the present invention.

FIG. 2 is a schematic view (exploded view) illustrating a specific example of a configuration of the cutting device 20.

FIG. 3 is a schematic view (an exploded view and a completion drawing) illustrating an example of a configuration of the case 22.

FIG. 4 is a schematic view illustrating an example of a configuration in which the body 20A and the cutter unit 20B are attachable to and detachable from each other.

FIG. 5 is a schematic view illustrating an action produced when an object is cut by the cutting system 1.

FIG. 6 is a schematic view illustrating an example of a configuration of the cutting system 1 that can perform cutting in any of two opposite directions.

FIG. 7 is a schematic view illustrating a modification of the cutter unit 20B.

FIG. 8 is a schematic view illustrating a modification of the cutter unit 20B. Description of Embodiments

An embodiment of the present invention is described below with reference to the drawings.

### FIRST EMBODIMENT

### Configuration

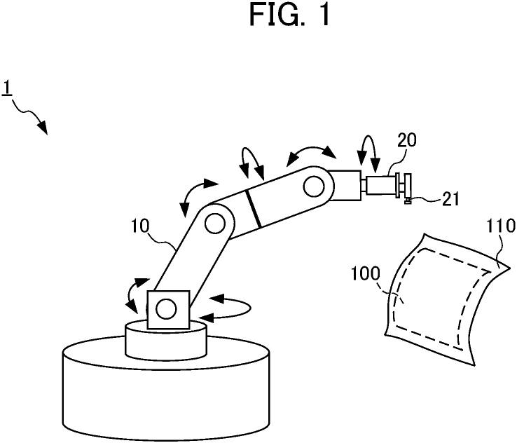

FIG. 1 is a schematic view illustrating an overall configuration of a cutting system 1 according to the present invention.

The cutting system 1 is a device that cuts a film 110. In particular, the cutting system 1 can easily cut the film 110 attached to a workpiece 100 having a three-dimensional shape (e.g., a curved surface shape) at any posture along the workpiece 100.

In the following description, examples of a member called the film 110 include various members attached to the workpiece 100 and, for example, include attached objects called a film, a seal, a sheet, and a web.

As illustrated in FIG. 1, the cutting system 1 includes an articulated robot 10 and a cutting device 20.

The articulated robot 10 (transport device) is, for example, a six-axis vertical articulated robot. The articulated robot 10 is equipped with the cutting device 20, and the articulated robot 10 cuts the film 110 attached to the workpiece 100 by controlling the cutting device 20 to desired position and posture.

The cutting device 20 has a rotary blade 21 that is rotated by a motor, and cuts the film 110 while holding the film 110.

The cutting device 20 is configured such that the rotary blade 21 is covered with a cutter unit 20B (later described), a part of the cutter unit 20B is opened, and a part of the rotary blade 21 is exposed from the opened part. In a case where the film 110 is cut, the articulated robot 10 equipped with the cutting device 20 moves the cutting device 20 while changing the posture of the cutting device 20. In this way, the film 110 can be cut by the rotary blade 21 while being held by the opening of the cutter unit 20B.

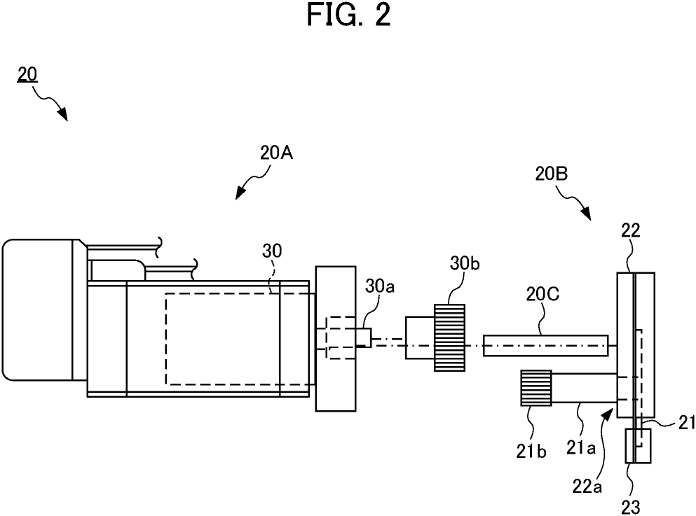

FIG. 2 is a schematic view (exploded view) illustrating a specific example of a configuration of the cutting device 20.

As illustrated in FIG. 2, in the cutting system 1, the cutting device 20 is configured such that a body 20A and the cutter unit 20B are linked by a linking part 20C and the body 20A and the cutter unit 20B are attachable to and detachable from each other.

The body 20A includes a motor 30 that rotates the rotary blade 21, and a rotary shaft 30a of the motor 30 protrudes from an end surface of the body 20A. The rotary shaft 30a of the motor 30 is provided with a gear wheel 30b that is engaged with a gear wheel 21b provided on a rotary shaft 21a of the rotary blade 21.

The cutter unit 20B includes the rotary blade 21, a case 22, and a guiding part 23.

The rotary blade 21 cuts an object to be cut (the film 110 in this case) by rotating about the rotary shaft 21a. The rotary shaft 21a of the rotary blade 21 is provided with the gear wheel 21b, and the gear wheel 21b is engaged with the gear wheel 30b provided on the rotary shaft 30a of the motor 30 and transmits driving force of the motor 30 to the rotary blade 21.

In the present embodiment, the rotary shaft 21a of the rotary blade 21 is provided parallel with the rotary shaft 30a of the motor 30, and the rotary blade 21 rotates within a plane parallel with the end surface of the body 20A accordingly.

The case 22 is a plate-shaped member that has therein a space for housing the rotary blade 21. In the present embodiment, the case 22 houses ½ or more of a diameter of the rotary blade 21, and a part of the rotary blade 21 is exposed from the case 22. The case 22 has, in a back surface, a through hole 22a through which the rotary shaft 21a of the rotary blade 21 is inserted.

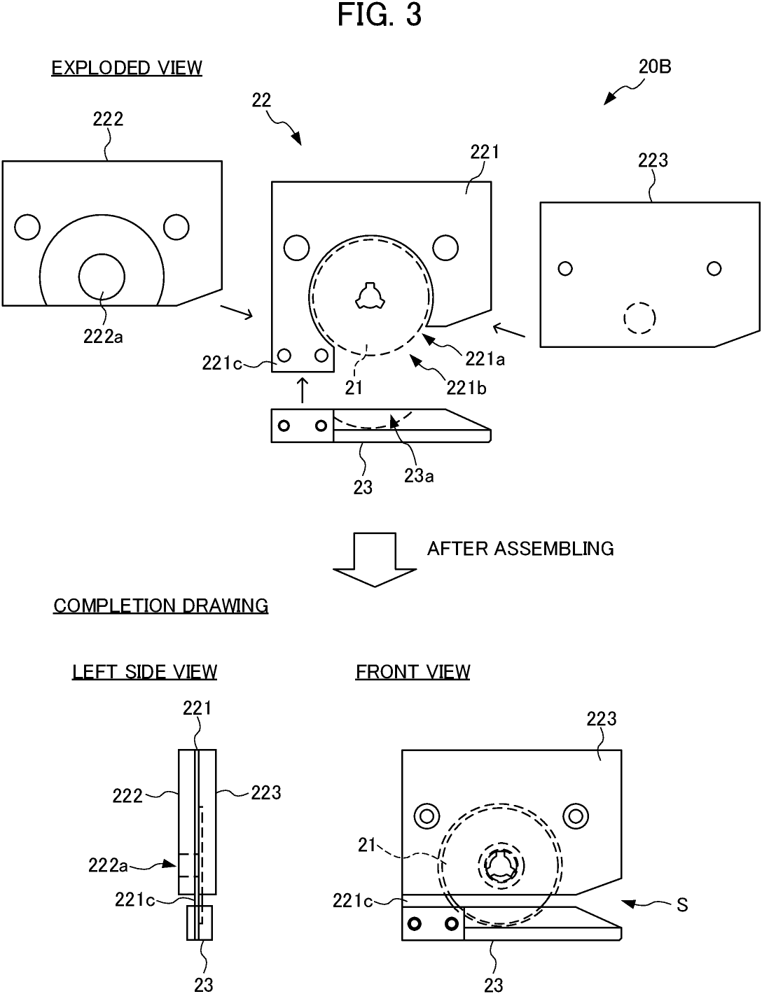

FIG. 3 is a schematic view (an exploded view and a completion drawing) illustrating an example of a configuration of the case 22.

As illustrated in FIG. 3, the case 22 includes a support member 221, a back-surface-side plate member 222, and a front-surface-side plate member 223.

The support member 221 is a support body that supports the back-surface-side plate member 222 and the front-surface-side plate member 223 and has, at a center thereof, a circular hollow part 221a that has an inner diameter larger than a diameter of the rotary blade 21. Furthermore, the support member 221 has, on one end side (a lower end side in FIG. 3), a part (hereinafter referred to as an opened part 221b″) where a member that surrounds the hollow part 221a is not present.

The back-surface-side plate member 222 is a plate-shaped member that covers a back surface side of the support member 221 and has a shape covering ½ or more (e.g., ¾) of the diameter of the rotary blade 21. One end side (a lower end side in FIG. 3) of the back-surface-side plate member 222 is disposed at a boundary (an upper end of the opened part 221b in FIG. 3) with a part of the support member 221 where the opened part 221b is provided. The back-surface-side plate member 222 has, in a part facing a center of the hollow part 221a of the support member 221 when the back-surface-side plate member 222 is attached to the support member 221, a through hole 222a through which the rotary shaft 21a of the rotary blade 21 is inserted.

The front-surface-side plate member 223 is a plate-shaped member that covers a front surface side of the support member 221 and has a shape covering ½ or more (e.g., ¾) of the diameter of the rotary blade 21, as with the back-surface-side plate member 222. One end side (a lower end side in FIG. 3) of the front-surface-side plate member 223 is disposed at the boundary (the upper end of the opened part 221b in FIG. 3) with the part of the support member 221 where the opened part 221b is provided, as with the back-surface-side plate member 222.

When the back-surface-side plate member 222 and the front-surface-side plate member 223 are disposed with the support member 221 interposed therebetween, the back-surface-side plate member 222 and the front-surface-side plate member 223 cover a part of the support member 221 extending to the upper end of the opened part 221b by sandwiching this part, and a leading end side (a lower end side in FIG. 3) relative to the opened part 221b protrudes from the back-surface-side plate member 222 and the front-surface-side plate member 223. Hereinafter, a part of the support member 221 that protrudes from the back-surface-side plate member 222 and the front-surface-side plate member 223 is referred to as a protruding support part 221c.

The guiding part 23 is a member having a substantially rectangular parallelepiped shape provided on the protruding support part 221c of the support member 221 and has a groove part 23a, which is a space in which a part (a lower end part in FIG. 3) of the rotary blade 21 rotates. One end side (a lower end side in FIG. 3) of the guiding part 23 functions as a protection member that covers an outer edge of the rotary blade 21 in a case where the guiding part 23 is provided on the protruding support part 221c, and a gap through which the film 110 passes is formed between the other end side (an upper end side in FIG. 3) of the guiding part 23 and one end sides (lower end sides in FIG. 3) of the back-surface-side plate member 222 and the front-surface-side plate member 223, and thereby the film 110 is guided to the rotary blade 21.

In a case where the guiding part 23 is provided on the protruding support part 221c of the support member 221, a part of the rotary blade 21 is exposed in a space (hereinafter referred to as a “space for cutting S”) formed between the back-surface-side plate member 222 and the front-surface-side plate member 223 and the guiding part 23.

In the present embodiment, a side (i.e., an opened side) of the space for cutting S where the support member 221 is not present is an opening where the object to be cut (the film 110) is inserted. Parts of the case 22 and the guiding part 23 that form the opening of the space for cutting S are inclined so that an opening width of the opening increases in a direction toward an end part (opened end) of the opening. This can realize a structure that allows the object to be cut to be easily introduced into the space for cutting S. Note that as for a shape of the opening, it is desirable that the opening width of the opening and a distance from the opening to the rotary blade 21 be set to such a degree that a human finger or the like does not make contact with the rotary blade 21 in order to prevent an operator’s body from making contact with the rotary blade 21.

In the space for cutting S, an angle formed between the rotary blade 21 and the guiding part 23 is an acute angle, and the rotary blade 21 rotates in a direction that draws the object to be cut from the opening of the space for cutting S into the space for cutting S. This produces an action of holding the object to be cut between the rotary blade 21 and the guiding part 23, and this action allows the object to be smoothly cut while giving local tension to a cut part even in a state where no tension is given to the object.

Furthermore, the object that has been cut passes both sides of the protruding support part 221c after passing both sides of the rotary blade 21. The protruding support part 221c has only a thickness of the support member 221, and therefore, for example, an action of excessively separating cut pieces of the object from each other is not produced, and a possibility of lowering quality of the object is kept low.

Note that the protruding support part 221c need just be strong enough to support the guiding part 23 with respect to the case 22 and therefore may be made thinner than the other part of the support member 221 as long as the strength is maintained. The protruding support part 221c may have a shape (e.g., a tapered shape) that is thin on a side close to the rotary blade 21 of the protruding support part 221c and becomes thicker in a direction away from the rotary blade 21 since it is only necessary to secure a strength that allows the object that has been cut to properly pass both sides of the protruding support part 221c and supports the guiding part 23 with respect to the case 22. Furthermore, the protruding support part 221c may be a member having a higher strength than the other part of the support member 221, and thereby the protruding support part 221c may be made thin while securing a strength. For example, the protruding support part 221c may be made of stainless steel, and the other part of the support member 221 may be made of aluminum.

### Attachment and Detachment Function of Cutting System

In the cutting system 1 having the above configuration, the body 20A and the cutter unit 20B are easily attachable to and detachable from each other.

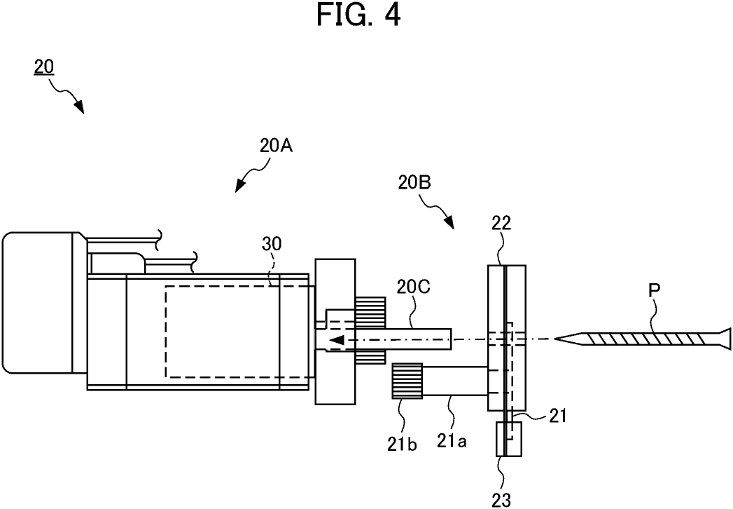

FIG. 4 is a schematic view illustrating an example of a configuration in which the body 20A and the cutter unit 20B are attachable to and detachable from each other.

As a structure for assembling the body 20A and the cutter unit 20B, for example, a structure in which the linking part 20C is fixed to the end surface of the body 20A by penetrating a screw P from a front-surface-side plate member 223 side of the cutter unit 20B may be employed.

In a case where such a structure is employed, the cutter unit 20B can be detached and replaced without taking the rotary blade 21 out when the rotary blade 21 is replaced, for example, because of blade degradation.

Note that instead of the structure of the linking part 20C for fixing the cutter unit 20B to the body 20A with a screw, a fitting structure may be provided between the end surface of the body 20A and the back-surface-side plate member 222 of the cutter unit 20B. In this case, during use, the body 20A and the cutter unit 20B may be assembled by fitting the fitting structure. Meanwhile, for example, at a time of replacement of the cutter unit 20B, the cutter unit 20B may be detached from the body 20A by releasing the fitting structure.

### Action

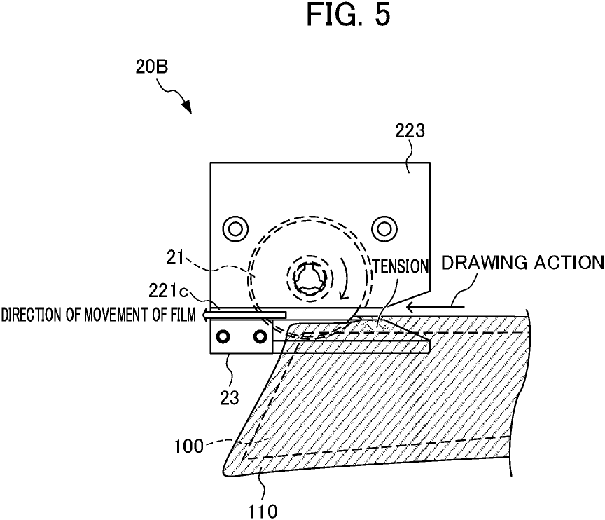

FIG. 5 is a schematic view illustrating an action produced when an object is cut by the cutting system 1.

As illustrated in FIG. 5, in the cutting system 1, the cutting device 20 is mounted as a tool of the articulated robot 10, and an object to be cut (the film 110) can be cut while controlling a position and a posture of the cutting device 20 to desired position and posture by the articulated robot 10.

In the example illustrated in FIG. 5, a state where the film 110 attached to the workpiece 100 that is a substrate (e.g., a glass substrate) having a three-dimensional shape having a curved surface is cut along a peripheral edge of the workpiece 100 is illustrated.

In a case where the cutting system 1 cuts the film 110, the workpiece 100 is held in a space within an operation range of the articulated robot 10, for example, by sucking the workpiece 100 to which the film 110 has been attached. In this state, one end of a peripheral part of the film 110 that sticks out from the workpiece 100 is a free end to which no tension is being given.

The articulated robot 10 moves the cutting device 20 toward the film 110 in this state while rotating the motor 30, and thereby brings the film 110 into the rotary blade 21 through the opening.

Since the opening width of the opening increases in a direction toward an end thereof, the film 110 can be easily introduced.

A drawing action produced by rotation of the rotary blade 21 draws the film 110 into the space for cutting S, and local tension (tension produced by resistance of the film 110 against drawing into the groove part 23a) is given since the angle formed between the rotary blade 21 and the guiding part 23 is an acute angle. As a result, the film 110 is smoothly cut.

When the articulated robot 10 moves the cutting device 20 in a direction of cutting of the film 110, the film 110 that has been cut moves toward a rear side of the cutting device 20 (in a direction indicated by the white arrow in FIG. 5) by passing both sides of the rotary blade 21 and both sides of the protruding support part 221c.

Since the protruding support part 221c has only the thickness of the support member 221, an action such as excessively separating cut parts of the film 110 is not produced, and therefore a possibility of lowering quality of the film 110 is kept low.

Since the articulated robot 10 can cut the film 110 at desired position and posture within the operation range, the film 110 can be properly cut along the peripheral edge of the workpiece 100 even in a case where the workpiece 100 has a complicated shape.

As described above, according to the cutting system 1 according to the present embodiment, the cutter unit 20B having the space for cutting S is mounted on the articulated robot 10, and an unnecessary part of the film 110 attached to the workpiece 100 is cut by the rotary blade 21 that is partially exposed in the space for cutting S while controlling the position and posture of the cutter unit 20B to desired position and posture by the articulated robot 10.

The opening of the space for cutting S has a widening opening width, an angle formed between the rotary blade 21 and a member (the guiding part 23) that forms the space for cutting S is an acute angle, and the rotary blade 21 rotates in a direction that draws an object to be cut from the opening of the space for cutting S into the space for cutting S.

Accordingly, the film 110 can be easily introduced into the space for cutting S, and an action of holding the film 110 between the rotary blade 21 and the guiding part 23 is produced, and this action allows the film 110 to be smoothly cut while giving local tension to a cut part even in a state where no tension is being given to the film 110.

Therefore, according to the cutting system 1, a sheet-shaped member can be more properly cut.

Furthermore, since the rotary blade 21 is housed in the case 22 and the guiding part 23 and only a part of the rotary blade 21 is exposed in the space for cutting S, an operator’s body (e.g., finger) is less likely to make contact with the rotary blade 21.

Furthermore, since the film 110 that has been cut and passed both sides of the rotary blade 21 passes both sides of the protruding support part 221c, which has only the thickness of the support member 221, an action such as excessively separating cut parts of the film 110 is not produced, and therefore a possibility of lowering quality of the cut film 110 is kept low.

In the cutting system 1, the cutting device 20 and the workpiece 100 are unlikely to interfere with each other. That is, the body 20A of the cutting device 20 is offset toward a side opposite to the guiding part 23 (for example, toward an upper side in FIG. 4) relative to the position of the space for cutting S. Therefore, according to the cutting system 1, the film 110 can be cut at a position close to an end edge of the workpiece 100.

Furthermore, since a rotation surface of the rotary blade 21 is parallel with the end surface of the body 20A, a motion during cutting can be made larger in a direction in which the articulated robot 10 rotates than in a direction in which an arm of the articulated robot 10 stretches and contracts in a case where the body 20A is attached as a tool of the articulated robot 10. Accordingly, a degree of freedom of control of the position and posture of the cutting device 20 by the articulated robot 10 can be made high.

Furthermore, according to the cutting system 1, in a case where the film 110 is attached to both surfaces of the workpiece 100 such as a substrate and an end part of the film 110 attached to one surface of the workpiece 100 is to be cut, only the film 110 to be cut of the films 110 attached to surfaces (a front surface and a rear surface) that are close to each other can be guided from the opening of the space for cutting S into the space for cutting S with certainty. As a result, the film 110 can be cut properly.

### Modification 1

In the above embodiment, the cutter unit 20B of the cutting device 20 includes the protruding support part 221c and the guiding part 23, and the guiding part 23 provided on the protruding support part 221c covers a part (a lower end part in FIG. 3) of the rotary blade 21 that protrudes from the case 22.

Meanwhile, the cutter unit 20B may be configured not to include the protruding support part 221c and the guiding part 23 and may be combined with a cutting stage having a groove in which the rotary blade 21 protruding from the case 22 is fitted and movable. In this way, the cutting system 1 can perform cutting in any of two opposite directions.

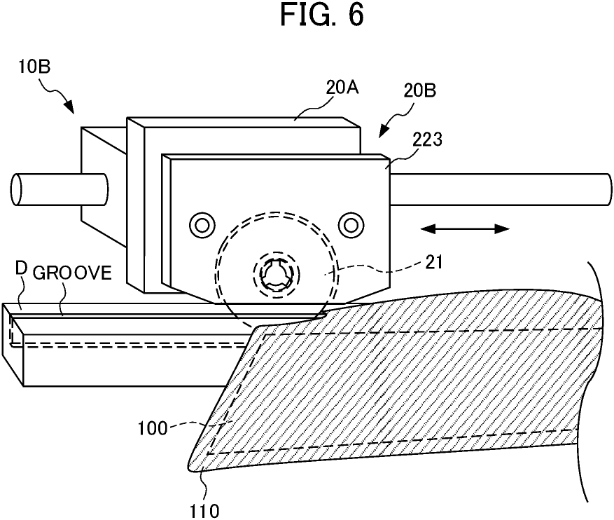

FIG. 6 is a schematic view illustrating an example of a configuration of the cutting system 1 that can perform cutting in any of two opposite directions.

In the example of the configuration illustrated in FIG. 6, the cutting system 1 includes a transport device 10B, the cutting device 20, and a cutting stage D.

As described above, the cutter unit 20B of the cutting device 20 is different from the cutter unit 20B according to the first embodiment in that the cutter unit 20B does not include the protruding support part 221c and the guiding part 23 and the rotary blade 21 protrudes from the case 22.

The transport device 10B can be, for example, an air cylinder that linearly moves. The cutting device 20 is mounted on the transport device 10B, and the cutting device 20 is moved in any of two opposite directions by the linear motion of the transport device 10B. However, the cutting device 20 may be linearly moved by the articulated robot 10.

The cutting stage D has a groove in which the rotary blade 21 is fitted, and the transport device 10B moves the cutting device 20 so that the rotary blade 21 moves inside the groove of the cutting stage D.

This can realize a configuration suitable for a case where the film 110 is successively cut along a straight line in the same direction, for example, in a case where the film 110 fed out from a roll is successively cut.

According to such a configuration, the film 110 can be cut while giving tension to the film 110 by pressing the film 110 against the cutting stage D.

Even in a case where such a configuration is employed, the rotary blade 21 can be easily replaced by employing a structure in which the cutter unit 20B is attachable to and detachable from the body 20A.

### Modification 2

Although an example of a configuration of the cutting device 20 in which the rotary shaft of the motor 30 and the rotary shaft of the rotary blade 21 are parallel has been described in the above embodiment, this is not restrictive.

For example, the rotary blade 21 may be rotated within a plane perpendicular to the end surface of the body 20A by transmitting rotational force of the rotary shaft of the motor 30 to the rotary blade 21 after bending the rotational force by 90 degrees with the use of a gear (e.g., a bevel gear).

In this case, as in the above embodiment, the film 110 can be easily introduced into the space for cutting S, and an action of holding the film 110 between the rotary blade 21 and the guiding part 23 is produced, and this action allows the film 110 to be smoothly cut while giving local tension to a cut part even in a state where no tension is being given to the film 110 although a direction of movement of the cutting device 20 during cutting is different from that in the above embodiment.

### Modification 3

Although a case where the protruding support part 221c of the cutter unit 20B is disposed at a position immediately following the rotary blade 21 (immediately following the rotary blade 21 on a downstream side in a direction of movement of the film 110) has been described as an example in the above embodiment, this is not restrictive. That is, the protruding support part 221c of the cutter unit 20B may be spaced apart from the rotary blade 21.

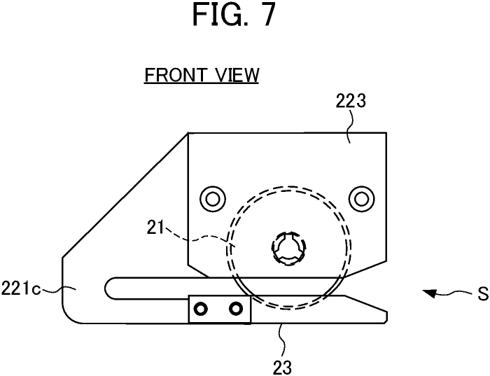

FIG. 7 is a schematic view illustrating a modification of the cutter unit 20B. As illustrated in FIG. 7, the cutter unit 20B according to the present modification is different from the cutter unit 20B illustrated in FIG. 3 in that the protruding support part 221c is spaced apart from a position immediately following the rotary blade 21 by a predetermined distance (e.g., approximately several centimeters). A space (hereinafter referred to as a “film flowing-down space”) where no member is present is formed between the position immediately following the rotary blade 21 and the protruding support part 221c, and the film 110 that has been cut by the rotary blade 21 moves through the film flowing-down space immediately after cutting.

Accordingly, the film 110 immediately after cutting by the rotary blade 21 moves through the film flowing-down space without a member having a thickness interposed therebetween, and passes both sides of the protruding support part 221c when the film 110 is away by a certain distance from a cutting position where the film 110 is cut by the rotary blade 21.

It is therefore possible to prevent, for example, the film 110 from being torn at a position followed by the cutting position of the rotary blade 21 due to a member having a thickness interposed between the film 110 immediately after cutting.

In the cutting system 1, the body 20A of the cutting device 20 is offset toward the side opposite to the guiding part 23 (e.g., toward the upper side in FIG. 4) relative to the position of the space for cutting S.

Accordingly, in a case where the cutter unit 20B illustrated in FIG. 7 is attached to the body 20A, the film 110 can be cut irrespective of which side the body 20A is located relative to the workpiece 100 (irrespective of whether the body 20A is located on a workpiece 100 side or is located on a side opposite to the workpiece 100).

### Modification 4

Although a case where the protruding support part 221c of the cutter unit 20B is disposed at a position immediately following the rotary blade 21 (at a position immediately following the rotary blade 21 on a downstream side in a direction of movement of the film 110) has been described as an example in the above embodiment, this is not restrictive. That is, a film flowing-down space where no member is present may be provided at a position immediately following the rotary blade 21 as in the example illustrated in Modification 3, and a rear end of the protruding support part 221c may be bent toward a side opposite to the body 20A.

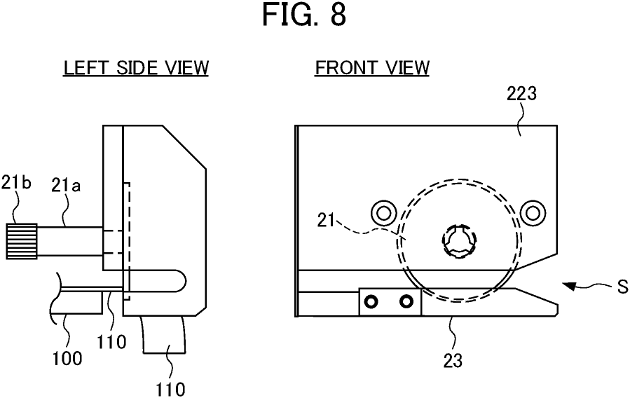

FIG. 8 is a schematic view illustrating a modification of the cutter unit 20B. As illustrated in FIG. 8, the cutter unit 20B according to the present modification is different from the cutter unit 20B illustrated in FIG. 7 in that a rear end (an end part on a downstream in a direction of movement of the film 110) of the support member 221 on which the protruding support part 221c is disposed apart from a position immediately following the rotary blade 21 by a predetermined distance (e.g., approximately several centimeters) is bent toward a side opposite to the body 20A (bent along a bending line in an up-down direction).

That is, a film flowing-down space where no member is present is provided on a downstream side relative to the rotary blade 21, and a rear end of the film flowing-down space is opened, and the protruding support part 221c is connected to a lower end part (a part where the guiding part 23 is provided) at a front end of the bent support member 221.

Accordingly, the film 110 attached to the workpiece 100 moves through the film flowing-down space and is discharged from the opened part at the rear end after being cut by the rotary blade 21. As a result, the film 110 attached to the workpiece 100 makes contact with no member after being cut by the rotary blade 21.

A cut piece of the film 110 cut by the rotary blade 21 moves while avoiding the bent rear end of the support member 221 as the cutting proceeds.

It is therefore possible to prevent dust from being generated and prevent quality of a product from deteriorating due to contact of the film 110 that has been cut with a member.

Note that the present invention can be, for example, modified and improved as appropriate as long as the effects of the present invention are produced, and is not limited to the above embodiment.

For example, a transport device such as the articulated robot 10 can not only cut an object to be cut (e.g., the film 110) by moving the cutting device 20, but also can cut the object to be cut by moving the object to be cut and the cutting device 20 relative to each other in various manners such as moving the object to be cut relative to the cutting device 20 or moving both of the object to be cut and the cutting device 20.

The configurations of the above embodiment and modifications can be combined as appropriate.

For example, the cutter unit 20B that can perform cutting in any of two opposite directions according to Modification 1 can be configured to transmit rotational force of the rotary shaft of the motor 30 to the rotary blade 21 by bending the rotational force by 90 degrees as in Modification 2.

As described above, the cutting system 1 according to the present embodiment includes the articulated robot 10 and the cutting device 20, and the cutting device 20 includes the body 20A and the cutter unit 20B.

The body 20A includes the motor 30 that rotates the rotary blade 21.

The cutter unit 20B includes the case 22 housing a part of the rotary blade 21 and the guiding part 23 that is linked to the case 22 and houses another part of the rotary blade 21, and has, between the case 22 and the guiding part 23, the space for cutting S into which an object to be cut (the film 110) is introduced. The articulated robot 10 moves the cutting device 20 and the object to be cut relative to each other.

A part of the rotary blade 21 is exposed in the space for cutting S, and the cutter unit 20B of the cutting device 20 is attachable to and detachable from the body 20A.

With this configuration, when the film 110 is introduced into the space for cutting S, an action of holding the film 110 between the rotary blade 21 and the guiding part 23 is produced, and this action allows the film 110 to be smoothly cut while giving local tension to a cut part even in a state where no tension is being given to the film 110.

Therefore, according to the cutting system 1, a sheet-shaped member can be more properly cut.

An opening width of the opening of the space for cutting S of the cutter unit 20B increases in a direction toward an opened end.

This allows the object to be cut to be easily introduced into the space for cutting S.

A part (the protruding support part 221c) of the cutter unit 20B on a side opposite to the opening of the space for cutting S is thinner than the other part.

As a result, an action such as excessively separating cut parts of the object is not produced, and therefore a possibility of lowering quality of the cut object can be kept low.

The part (the protruding support part 221c) of the cutter unit 20B on a side opposite to the opening of the space for cutting S becomes thicker in a direction away from the space for cutting S.

As a result, an action such as excessively separating cut parts of the object is not produced while securing support force linking the case 22 and the guiding part 23, and therefore a possibility of lowering quality of the cut object can be kept low.

The part (the protruding support part 221c) of the cutter unit 20B on a side opposite to the opening of the space for cutting S is spaced apart from the rotary blade 21, and a space (film flowing-down space) where no member is present is formed between this part and the rotary blade 21.

Accordingly, the film 110 immediately after cutting by the rotary blade 21 moves through the film flowing-down space without a member having a thickness interposed therebetween, and passes both sides of the protruding support part 221c when the film 110 is away by a certain distance from a cutting position at which the film 110 is cut by the rotary blade 21.

It is therefore possible to prevent, for example, the film 110 from being torn at a position followed by cutting position of the rotary blade 21 due to a member having a thickness interposed between the film 110 immediately after cutting.

The part (the protruding support part 221c) of the cutter unit 20B on a side opposite to the opening of the space for cutting S has, in a portion adjacent to the rotary blade 21, the space (film flowing-down space) where no member is present, and an end part thereof is bent along a bending line crossing a direction of relative movement of the cutter unit 20B and the film 110.

This prevents the film 110 attached to the workpiece 100 from making contact with a member after being cut by the rotary blade 21.

A cut piece of the film 110 cut by the rotary blade 21 moves while avoiding the bent rear end of the support member 221 as the cutting proceeds.

It is therefore possible to prevent dust from being generated and prevent quality of a product from deteriorating due to contact of the film 110 that has been cut with a member.

Although the embodiment of the present invention has been described above, the present invention is not limited to the above embodiment. The effects described in the present embodiment are most suitable effects produced by the present invention, and the effects of the present invention are not limited to the ones described in the present embodiment.

### REFERENCE SIGNS LIST

1 cutting system, 10 articulated robot, 10B transport device, 20 cutting device, 20A body, 20B cutter unit, 20C linking part, 21 rotary blade, 21a, 30a rotary shaft, 21b, 30b gear wheel, 22 case, 22a, 222a through hole, 221 support member, 221a hollow part, 221b opened part, 221c protruding support part, 222 back-surface-side plate member, 223 front-surface-side plate member, 23 guiding part, 23a groove part, 30 motor, 100 workpiece, 110 film, S space for cutting, P screw, D stage

1. A cutting system comprising:
a cutting device including a body having a motor that rotates a rotary blade and a cutter unit that includes a case housing a part of the rotary blade and a guiding part linked to the case and housing another part of the rotary blade and has, between the case and the guiding part, a space for cutting into which an object to be cut is introduced; and
a transport device that moves the cutting device and the object to be cut relative to each other,
wherein a part of the rotary blade is exposed in the space for cutting, and the cutter unit of the cutting device is attachable to and detachable from the body.

2. The cutting system according to claim 1, wherein
an opening width of an opening of the space for cutting of the cutter unit increases in a direction toward an opened end.

3. The cutting system according to claim 1, wherein
a part of the cutter unit on a side opposite to the opening of the space for cutting is thinner than an other part of the cutter unit.

4. The cutting system according to claim 1, wherein
a part of the cutter unit on a side opposite to the opening of the space for cutting becomes thicker in a direction away from the space for cutting.

5. The cutting system according to claim 1, wherein
a part of the cutter unit on a side opposite to the opening of the space for cutting is spaced apart from the rotary blade, and a space where no member is present is formed between the part and the rotary blade.

6. The cutting system according to claim 1, wherein
a part of the cutter unit on a side opposite to the opening of the space for cutting has, in a portion adjacent to the rotary blade, a space where no member is present, and an end part thereof is bent along a bending line crossing a direction of relative movement of the cutter unit and the object to be cut.

7. A cutting system comprising:
a cutting device including a body having a motor that rotates a rotary blade and a cutter unit including a case housing a part of the rotary blade;
a transport device that moves the cutting device and an object to be cut relative to each other; and
a cutting stage having a groove in which the rotary blade exposed from the case of the cutter unit is fitted,
wherein the cutter unit of the cutting device is capable of cutting the object to be cut in any of two opposite directions and is attachable to and detachable from the body.

8. A cutting device comprising:
a body having a motor that rotates a rotary blade; and
a cutter unit that includes a case housing a part of the rotary blade and a guiding part linked to the case and housing another part of the rotary blade and has, between the case and the guiding part, a space for cutting into which an object to be cut is introduced,
wherein the cutter unit is attachable to and detachable from the body.

9. A cutting device comprising:
a body having a motor that rotates a rotary blade; and
a cutter unit that includes a case housing a part of the rotary blade,
wherein the rotary blade exposed from the case of the cutter unit is fitted in a groove of an opposed member and cuts an object to be cut, and the cutter unit is capable of cutting the object to be cut in any of two opposite directions and is attachable to and detachable from the body.

10. A cutter unit comprising:
a case housing a part of a rotary blade; and
a guiding part linked to the case and housing another part of the rotary blade,
wherein the cutter unit has, between the case and the guiding part, a space for cutting into which an object to be cut is introduced.

11. A cutter unit comprising a case housing a part of a rotary blade,
wherein the rotary blade exposed from the case is fitted in a groove of an opposed member and cuts an object to be cut, and the rotary blade is capable of cutting the object to be cut in any of two opposite directions and is attachable to and detachable from another unit including a motor that rotates the rotary blade.
